(19) United States
(12) Patent Application Publication
(10) Pub. No.: US 2017/0153194 A1
(43) Pub. Date: Jun. 1, 2017

(54) FLASH INFRARED THERMOGRAPHY EXAMINATION - NONDESTRUCTIVE TESTING

(71) Applicant: Halliburton Energy Services, Inc., Houston, TX (US)

(72) Inventors: Kenneth Ray Coffman, Duncan, OK (US); David Mark Stribling, Duncan, OK (US); Matthew Rodney Margis, Lawton, OK (US)

(21) Appl. No.: 15/118,388

(22) PCT Filed: Jun. 20, 2014
(86) PCT No.: PCT/US2014/043372

§ 371 Date: Aug. 11, 2016

(51) Int. Cl. G01N 25/72; G01J 5/10; G01N 25/18

(52) U.S. Cl. CPC G01N 25/72; G01N 25/18; G01J 5/10; G01J 2005/0081

(57) ABSTRACT

A system and method for infrared (IR) thermography examination of a specimen under test are disclosed. One such method comprises one of imparting heat energy to the specimen under test with a heat energy source or removing heat energy from the specimen under test with a heat sink. Respectively, one of the heat energy source or the heat sink is removed. Using IR images, areas of surface heat transfer discontinuity of a surface temperature distribution of the specimen under test are identified to determine a distribution of a filler material in a base material of the specimen under test.

### BACKGROUND

Valve inserts can be used to substantially reduce leakage past the valve. The valve typically closes onto the insert such that the insert substantially isolates one side of the valve from the other. Thus, a gas and/or fluid can be kept from transiting the valve in the closed position.

For proper operation of the valve insert, it is useful to have a certain composition of the insert relative to its role in the valve. It is thus desirable to be able to test a composition of an insert.

### BRIEF DESCRIPTION OF THE DRAWINGS

FIG. 1 illustrates an embodiment of an exploded view of a valve assembly that includes a valve insert.

FIG. 2 illustrates a block diagram of an embodiment of a test system for nondestructive testing using infrared thermography examination.

FIG. 3 illustrates a block diagram of another embodiment of a test system for nondestructive testing using infrared thermography examination.

FIG. 4 illustrates a diagram of indications of a change in temperature.

FIG. 5 illustrates a flowchart of an embodiment of a method for nondestructive testing in accordance with the embodiment of FIG. 2.

FIG. 6 illustrates a flowchart of an embodiment of a method for nondestructive testing in accordance with the embodiment of FIG. 3.

### DETAILED DESCRIPTION

The system and methods disclosed herein refer to nondestructive testing of valve inserts. The reference to valve inserts is for purposes of illustration only. The disclosed methods can be used on any item for which it is desirable to test that item's homogeneity through observing thermal conductivity.

A valve insert may include filler materials that have a relatively high thermal conductivity when compared to the rest of the insert composition (e.g., a base elastomer). Typical filler materials can include any carbon-based material such as metals, polymers, and/or any engineered material composite. For example, an engineered composite might include a filler material having one or more metals in addition to a polymer.

The filler material can provide resistance to wear from contact with the seat. Thus, the areas of relatively low concentrations of the filler material in the insert can result in higher wear than in the other areas of the insert. It is therefore desirable to determine that the distribution of the filler materials in a particular insert is relatively uniform enough to provide even wear throughout the insert.

Since the filler material is carbon-based, it has a relatively higher thermal conductivity than that of the base material (e.g., elastomer). Thus, the insert can exhibit an uneven heat transfer across the insert when the filler material is not uniformly distributed within the base material.

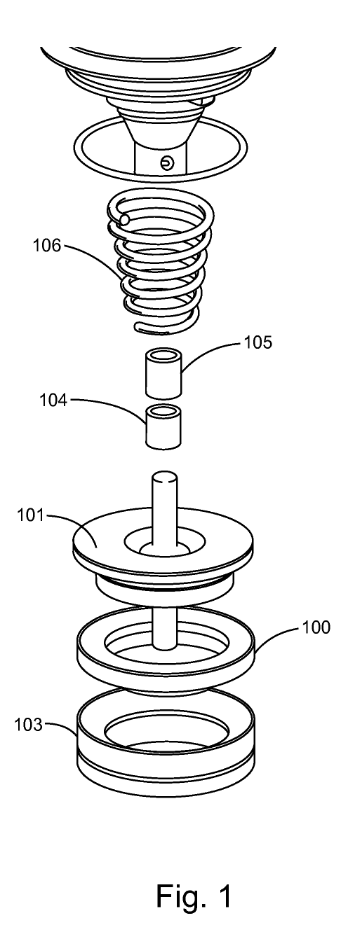

FIG. 1 illustrates an embodiment of an exploded view of a valve assembly that includes a valve insert. This embodiment is for purposes of illustration only since other possible specimens under test can be tested using the flash infrared thermography examination—nondestructive testing technique/method described subsequently.

The valve assembly can include the valve insert 100 that rests on the valve seat 103. The valve seat 103 can provide support to the valve insert 100. The valve insert 100 is attached to the valve 101. The resulting assembly is pushed against the valve seat 103 by the spring 106, forming a seal. Thus, the valve insert 100 can provide isolation of one side of the closed valve 101 from the other side. Bushings 104, 105 can be positioned over portions of the valve 101 to provide a surface for other parts of the valve assembly to move against during operation of the valve 101.

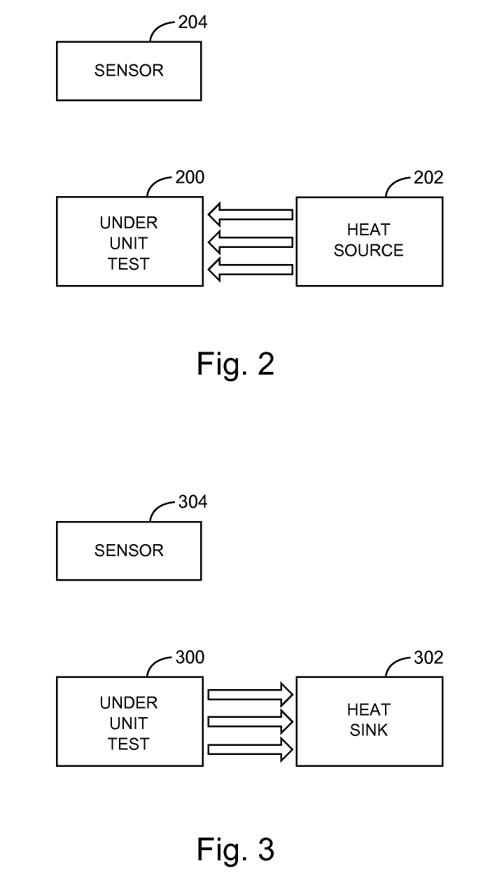

FIG. 2 illustrates a block diagram of an embodiment of a test system for nondestructive testing using infrared thermography examination. This embodiment uses a heat source 202 to add heat energy to a specimen under test specimen under test 200 (e.g., valve insert).

The system comprises the specimen under test 200 that is in relatively close proximity to a heat source 202 (i.e., close enough for the heat source to provide heat energy to the specimen under test without undue loss). The heat source can add heat energy to the specimen under test 200 in order to increase its temperature above ambient temperature. The heat source 202 can include any source of energy that can increase the temperature of the specimen under test 200 such as: heating coils, a flame, microwaves, or some other energy source.

The heat source 202 can increase the temperature of the specimen under test 200 directly or the specimen under test 200 can be placed in another medium (e.g., water) and the heat source 202 can be used to heat up the medium that, in turn, increases the temperature of the specimen under test 200. This may impart a more even distribution of the energy to the specimen under test 200.

A sensor 204 can be used to observe the temperature changes in the specimen under test 200. For example, an infrared (IR) image sensor can be used to sense an image of the specimen under test 200 in the IR light range. The one or more IR images may be recorded for later use or combined into a video for analysis. In another embodiment, the sensor 204 can be part of a video imaging system to make direct videos of the temperature change of the specimen under test 200 instead of still images.

FIG. 3 illustrates a block diagram of an embodiment of a test system for nondestructive testing using infrared thermography examination. This embodiment uses a cooling source 302 (e.g., heat sink) to remove heat energy from a specimen under test 100 (e.g., packer element). In an embodiment, the specimen under test 100 can be placed in a medium that is directly cooled, thus cooling the specimen under test.

The heat sink 302 transfers heat from the specimen under test 100. The heat sink 302 can be a cooling device such as a refrigeration unit or a cooling medium (e.g., water). The transfer of heat is stopped after the specimen under test 300 has reached a desired temperature and the sensor 304 (e.g., IR image sensor) can then record the heat distribution of the specimen under test 300 as heat is transferred from the surrounding medium to the specimen under test 300.

As is known in the art, heat naturally flows spontaneously from hot to cold. The sensor 204, 304 captures IR images of the heat flow out of (see FIG. 2) or into (see FIG. 3) the specimen under test 200, 300. Using the IR images, the surface temperature distribution of the specimen under test can be observed and measured for discontinuities in the heat transfer across the homogeneous material of the specimen under test 200, 300.

The heat transfer occurs as a result of the specimen under test 200, 300 returning to equilibrium with its surrounding medium (e.g., water, air). The greater the temperature difference between the specimen under test 200, 300 and the surrounding medium, the faster the heat transfer rate initially occurs. The heat transfer rate decreases as the specimen under test 200, 300 approaches equilibrium with the surrounding medium.

The test systems of FIGS. 2 and 3 can be combined into one test system. In such a system, both the heat source 202 and the cooling source 302 used to provide the heat transfer to/from the specimen under test 200, 300 can be provided by a single heating/cooling unit.

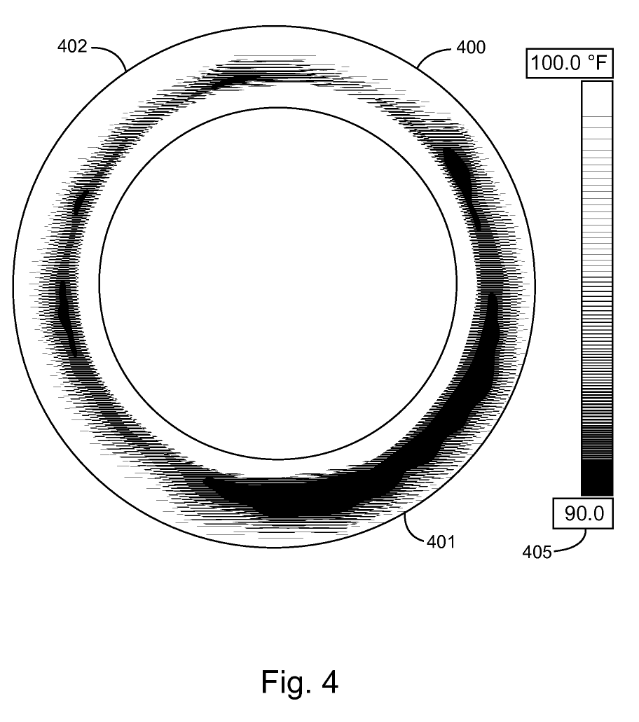

The discontinuities in heat transfer, as exhibited by the IR images, can illustrate uneven distribution of the filler material within the base material of the specimen under test 200, 300. Since the filler material has a higher thermal conductivity as compared to the base material, the areas having greater concentrations of the filler material heat up at a faster rate than areas having less filler material. Similarly, the areas having the greater concentrations of the filler material will cool down faster (i.e., higher heat transfer rate) than the areas having less filler material. These properties are illustrated in the diagram of FIG. 4.

FIG. 4 illustrates a diagram of indications of surface temperature variation across a valve insert. While this figure shows the temperature distribution across a valve insert acting as a specimen under test, other objects as specimens under test 400 can exhibit substantially similar properties.

The diagram of FIG. 4 illustrates the transfer of heat out of the specimen under test, as the unit gives off heat energy to return to equilibrium. The scale 405 to the right of the specimen under test 400 is calibrated for the transfer of heat from the specimen under test.

The specimen under test 400 of FIG. 4 also illustrates the transfer of heat into the specimen under test, as the ambient medium imparts heat into the cooled specimen under test. Only the scale 405 of FIG. 4 would need to change to reflect the different temperatures. The illustrated surface temperature distribution would not change.

FIG. 4 shows that the specimen under test 400 has an uneven surface temperature distribution. One portion 402 of the specimen under test 400 retains heat longer than another portion 401. Thus, the portion 401 that transfers heat to the ambient medium at a faster rate includes more of the conductive filler material than the portion 402 that transfers heat to the ambient medium at a slower rate. Thus, it can be seen that the specimen under test 400 (e.g., insert) of FIG. 4 includes an uneven filler material distribution. A specimen under test 400 having a more uniform filler material distribution would have a more evenly distributed temperature.

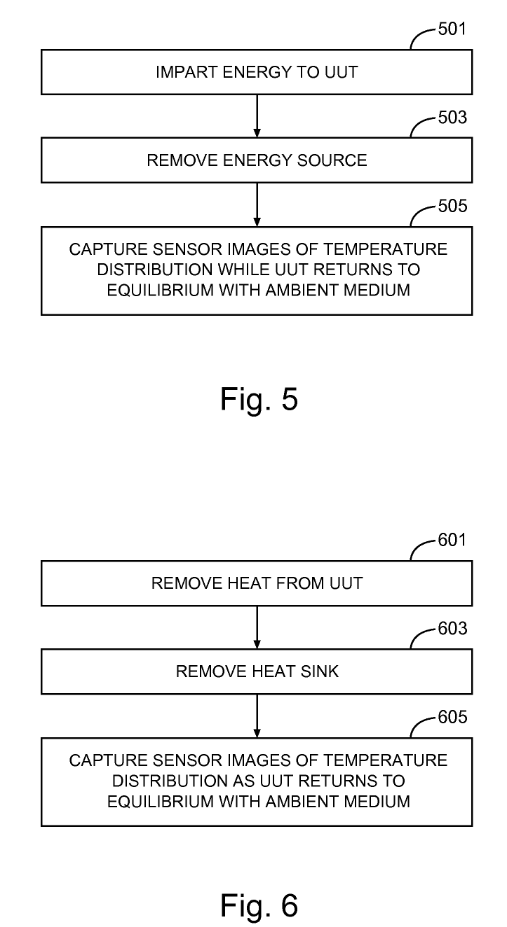

FIG. 5 illustrates a flowchart of an embodiment of a method for nondestructive testing in accordance with the embodiment of FIG. 2. Energy (e.g., heat) is imparted to a specimen under test at block 501. At block 503, the energy source is removed. The specimen under test is then allowed to return to equilibrium with the surrounding medium while the sensor captures images of the temperature distribution across the surface of the specimen under test, at block 505.

FIG. 6 illustrates a flowchart of an embodiment of a method for nondestructive testing in accordance with the embodiment of FIG. 3. At block 601, heat is removed from the specimen under test. At block 603, the heat sink is removed. The specimen under test is then allowed to return to equilibrium with the surrounding medium while the sensor captures images of the temperature distribution across the surface of the specimen under test, at block 605.

### Examples

Example 1 is a method for infrared (IR) thermography testing of a specimen under test, the method comprising one of imparting heat energy to the specimen under test with a heat energy source or removing heat energy from the specimen under test with a heat sink; one of removing the heat energy source or the heat sink; and identifying, with IR images, areas of surface heat transfer discontinuity of a surface temperature distribution of the specimen under test to determine a distribution of a filler material in a base material of the specimen under test.

In Example 2, the subject matter of Example 1 can further include wherein the specimen under test comprises a valve insert.

In Example 3, the subject matter of Examples 1-2 can further include wherein the specimen under test comprises a packer element.

In Example 4, the subject matter of Examples 1-3 can further include wherein the specimen under test is located in a medium and the method further comprises one of imparting the heat energy to the medium or removing the heat energy from the medium.

In Example 5, the subject matter of Examples 1-4 can further include wherein the medium is one of water or air.

In Example 6, the subject matter of Examples 1-5 can further include wherein identifying areas of surface heat transfer discontinuity of the surface temperature distribution of the specimen under test comprises identifying areas of the specimen under test having a higher heat transfer rate to a medium than other areas of the specimen under test.

In Example 7, the subject matter of Examples 1-6 can further include wherein imparting heat energy to the specimen under test with the heat energy source comprises imparting heat energy to the specimen under test with a microwave emitter.

In Example 8, the subject matter of Examples 1-7 can further include wherein removing heat energy from the specimen under test with the heat sink comprises removing heat energy from the specimen under test with a refrigeration unit.

Example 9 is a method for infrared (IR) thermography testing of a specimen under test, the method comprising: imparting energy to the specimen under test, with an energy source, to increase a temperature of the specimen under test; halting the imparting of energy to the specimen under test; and identifying, with IR images, a surface temperature distribution of the specimen under test to determine areas of surface heat transfer discontinuity to determine distribution of a filler material in a base material of the specimen under test.

In Example 10, the subject matter of Example 9 can further include wherein the energy source is one of a heat coil, a flame, or a microwave source.

In Example 11, the subject matter of Examples 9-10 can further include wherein halting the imparting of energy or halting the removing of the heat energy comprises allowing the specimen under test to return to equilibrium with a surrounding medium.

In Example 12, the subject matter of Examples 9-11 can further include wherein removing heat energy from the specimen under test comprises cooling the specimen under test with a cooling medium.

Example 13 is a system for performing nondestructive testing of a specimen under test, the system comprising: a heating/cooling unit to add heat energy to the specimen under test or remove heat energy from the specimen under test; and an infrared imaging sensor to capture infrared images of the specimen under test after the heat energy addition or removal has been halted, wherein the infrared images are to identify areas of surface heat transfer discontinuity to determine distribution of a filler material in a base material of the specimen under test.

In Example 14, the subject matter of Example 13 can further include wherein the filler material comprises a carbon-based material.

In Example 15, the subject matter of Examples 13-14 can further include wherein the specimen under test comprises an elastomer base material.

In Example 16, the subject matter of Examples 13-15 can further include wherein the filler material comprises a metallic material, a polymer material, or an engineered material.

In Example 17, the subject matter of Examples 13-16 can further include wherein the engineered material comprises a composite material including metal and polymer.

In Example 18, the subject matter of Examples 13-17 can further include a medium surrounding the specimen under test.

In Example 19, the subject matter of Examples 13-18 can further include wherein the medium is configured to be heated or cooled.

In Example 20, the subject matter of Examples 13-19 can further include wherein the infrared images are further to illustrate areas of relatively higher heat transfer as compared to other areas of the specimen under test.

This disclosure is intended to cover any and all adaptations or variations of various embodiments. Combinations of the above embodiments, and other embodiments not specifically described herein, will be apparent to those of skill in the art upon reviewing the above description.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for infrared (IR) thermography testing of a specimen under test, the method comprising:
one of imparting heat energy to the specimen under test with a heat energy source or removing heat energy from the specimen under test with a heat sink;
one of removing the heat energy source or the heat sink; and
identifying, with IR images, areas of surface heat transfer discontinuity of a surface temperature distribution of the specimen under test to determine a distribution of a filler material in a base material of the specimen under test.

2. The method of claim 1, wherein the specimen under test comprises a valve insert.

3. The method of claim 1, wherein the specimen under test comprises a packer element.

4. The method of claim 1, wherein the specimen under test is located in a medium and the method further comprises one of imparting the heat energy to the medium or removing the heat energy from the medium.

5. The method of claim 4, wherein the medium is one of water or air.

6. The method of claim 1, wherein identifying areas of surface heat transfer discontinuity of the surface temperature distribution of the specimen under test comprises identifying areas of the specimen under test having a higher heat transfer rate to a medium than other areas of the specimen under test.

7. The method of claim 1, wherein imparting heat energy to the specimen under test with the heat energy source comprises imparting heat energy to the specimen under test with a microwave emitter.

8. The method of claim 1, wherein removing heat energy from the specimen under test with the heat sink comprises removing heat energy from the specimen under test with a refrigeration unit.

9. A method for infrared (IR) thermography testing of a specimen under test, the method comprising:
one of imparting energy to the specimen under test, with an energy source, to increase a temperature of the specimen under test or removing heat energy from the specimen under test to decrease a temperature of the specimen under test;
one of halting the imparting of energy to the specimen under test or halting the removing of the heat energy; and
identifying, with IR images, a surface temperature distribution of the specimen under test to determine areas of surface heat transfer discontinuity to determine distribution of a filler material in a base material of the specimen under test.

10. The method of claim 9, wherein the energy source is one of a heat coil, a flame, or a microwave source.

11. The method of claim 9, wherein halting the imparting of energy or halting the removing of the heat energy comprises allowing the specimen under test to return to equilibrium with a surrounding medium.

12. The method of claim 9, wherein removing heat energy from the specimen under test comprises cooling the specimen under test with a cooling medium.

13. A system for performing nondestructive testing of a specimen under test, the system comprising:
a heating/cooling unit to add heat energy to the specimen under test or remove heat energy from the specimen under test; and
an infrared imaging sensor to capture infrared images of the specimen under test after the heat energy addition or removal has been halted, wherein the infrared images are to identify areas of surface heat transfer discontinuity to determine distribution of a filler material in a base material of the specimen under test.

14. The system of claim 13, wherein the filler material comprises a carbon-based material.

15. The system of claim 13, wherein the specimen under test comprises an elastomer base material.

16. The system of claim 13, wherein the filler material comprises a metallic material, a polymer material, or an engineered material.

17. The system of claim 16, wherein the engineered material comprises a composite material including metal and polymer.

18. The system of claim 13, further comprising a medium surrounding the specimen under test.

19. The system of claim 18, wherein the medium is configured to be heated or cooled.

20. The system of claim 13, wherein the infrared images are further to illustrate areas of relatively higher heat transfer as compared to other areas of the specimen under test.
